(19) United States
(12) Patent Application Publication
(10) Pub. No.: US 2020/0238581 A1
(43) Pub. Date: Jul. 30, 2020

(54) SEWN WORKPIECE AND MOLDING METHOD FOR THE SAME

(71) Applicant: HONDA MOTOR CO., LTD., Tokyo (JP)

(72) Inventors: Tohru Takamura, Hagagun (JP); Rikiya Suwa, Hagagun (JP); Yosuke Ikadai, Hagagun (JP); Hajime Miyamoto, Hagagun (JP); Mitsutaka Igaue, Hagagun (JP); Noboru Hirano, Hagagun (JP)

(21) Appl. No.: 16/740,538

(22) Filed: Jan. 13, 2020

(30) Foreign Application Priority Data
Jan. 24, 2019 (JP) 2019-009849

(51) Int. Cl. B29C 45/14; D05B 3/12; B29L 31/30; B60K 37/00

(52) U.S. Cl. CPC B29C 45/14786; D05B 3/12; D10B 2505/12; B60K 37/00; B29L 2031/3005; B60K 2370/65; D05D 2303/12

(57) ABSTRACT

In a sewn workpiece in which a sewn part that needs to be sewed is provided to a base material made of resin, the sewn part includes a bent part, and a hole for guiding a sewing needle from a front surface side of the base material to a back surface side thereof is provided to the bent part.

### CROSS-REFERENCE TO RELATED APPLICATION

This application is based upon and claims the benefit of priority from Japanese Patent Application No. 2019-009849 filed on Jan. 24, 2019, the contents of which are incorporated herein by reference.

### BACKGROUND OF THE INVENTION

### Field of the Invention

The present invention relates to a sewn workpiece in which a sewn part that needs to be sewed is provided to a base material made of resin, and a molding method for the sewn workpiece.

### Description of the Related Art

Japanese Laid-Open Patent Publication No. 2017-013659 discloses a technique for providing a stitch pattern with the use of a sewing needle and a sewing thread to a workpiece made of resin or an interior component of a vehicle, such as a dashboard (also referred to as instrument panel). In the present specification, a workpiece in which a sewn part that needs to be sewed is provided to a base material made of resin is referred to as a sewn workpiece.

### SUMMARY OF THE INVENTION

When the sewing needle is penetrated through the sewn part, the sewing needle is burdened. As disclosed in Japanese Laid-Open Patent Publication No. 2017-013659, in a case of providing a stitch pattern to a flat sewn part, it is relatively easy to penetrate the sewing needle through the sewn part. Meanwhile, the sewn part may include a bent part. When the sewing needle is penetrated through the bent part, the sewing needle is heavily burdened and moreover, reaction force is generated by the bent part in directions other than a penetrating direction. For this reason, sewing the bent part is difficult and the sewing needle may even be broken. In addition, the sewing needle may be broken because of slipping on a surface of the bent part.

The present invention has been made in view of the above problem, and an object is to provide a sewn workpiece where the bent part is easily sewed, and a molding method for the sewn workpiece.

A first aspect of the present invention is a sewn workpiece in which a sewn part that needs to be sewed is provided to a base material made of resin, wherein: the sewn part includes a bent part; and a hole is provided in the bent part at a position where a sewing needle is penetrated.

By the above structure, the hole is provided to the bent part of the base material in advance; therefore, the reaction force that the sewing needle receives from the base material in the sewing of the bent part can be reduced. In addition, since an end of the sewing needle is inserted into the hole in the sewing of the bent part, the sewing needle does not slip on a surface of the bent part and needle slip, needle break, and sewing failure can be prevented.

A second aspect of the present invention is a method of molding a sewn workpiece for molding a base material made of resin including a sewn part that needs to be sewed, wherein injection molding is performed using a die including a protrusion in a bend molding part, in a manner that a bent part is molded in the sewn part of the base material by the bend molding part and that a hole is molded in the bent part by the protrusion at a position where a sewing needle is penetrated.

By the above structure, the sewn workpiece in which the reaction force that the sewing needle receives from the base material is reduced can be manufactured. In this sewn workpiece, the needle slip, the needle break, and the sewing failure can be prevented.

According to the present invention, the bent part can be sewed easily and the sewing process can be performed efficiently.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an external view of a part of a base material (sewn workpiece) according to one embodiment;

FIG. 2A is a cross-sectional view taken along IIA-IIA of the base material illustrated in FIG. 1, and FIG. 2B is a cross-sectional view taken along IIA-IIA of the base material having a skin attached to a surface of the base material;

FIG. 3 is a cross-sectional view of the sewn workpiece that has been sewed;

FIGS. 4A, 4B, and 4C are cross-sectional views each illustrating a hole;

FIG. 5 is an explanatory view for describing a molding method for the hole illustrated in FIG. 4A; and

FIG. 6 is an explanatory view for describing a molding method for the hole illustrated in FIG. 4B.

### DESCRIPTION OF THE PREFERRED EMBODIMENTS

Preferred embodiments of a sewn workpiece and a molding method for the same according to the present invention are hereinafter described in detail with reference to the attached drawings.

### [1. Structure of Sewn Workpiece 10]

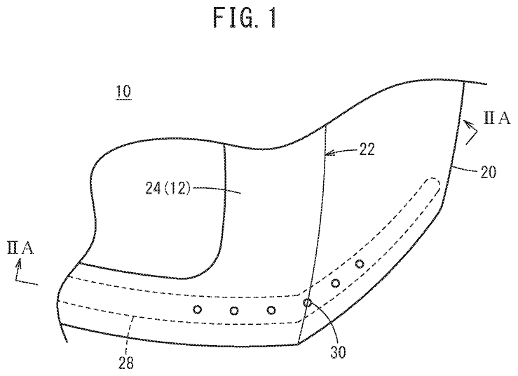

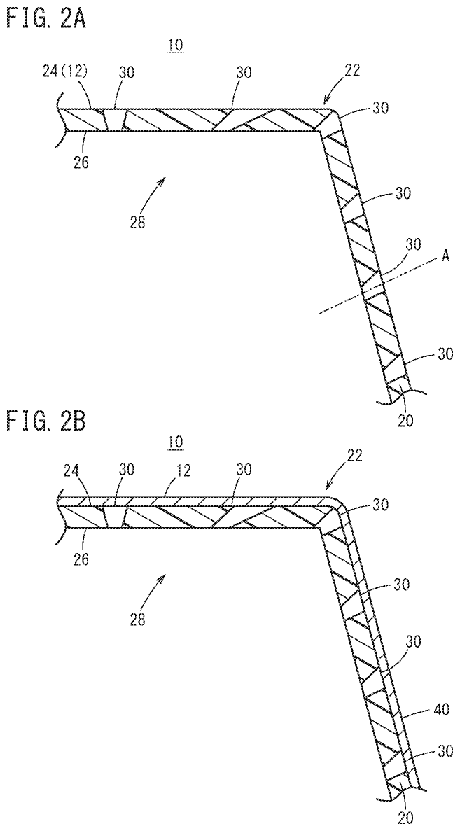

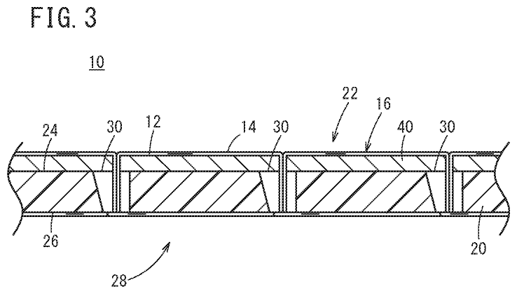

A sewn workpiece 10 is used as an interior component of a vehicle, for example a dashboard (instrument panel) or the like. The sewn workpiece 10 may have nothing on a front surface 24 of a base material 20 made of resin as illustrated in FIG. 1 or FIG. 2A, or may be provided with a skin 40 attached with an adhesive or the like to the front surface 24 of the base material 20 made of resin as illustrated in FIG. 2B. In the description below, the sewn workpiece 10 is in the state illustrated in FIG. 2B. As illustrated in FIG. 3, on a design surface 12 of the sewn workpiece 10, a stitch pattern 16 is formed by a sewing needle (not illustrated) and a sewing thread 14.

The base material 20 includes a bent part 22 that is angular or round. The bent part 22 may have either a protruding shape or a depressed shape when viewed from a side of the front surface 24 of the base material 20. A position on the base material 20 corresponding to the stitch pattern 16 to be formed on the sewn workpiece 10 is referred to as a sewn part 28. In the present embodiment, the sewn part 28 is provided to cover the bent part 22. In other words, the sewn part 28 includes the bent part 22.

As illustrated in FIG. 2A and FIG. 2B, one or a plurality of holes 30 are provided to the bent part 22 in the sewn part 28. The hole 30 is provided at a position where the sewing needle is penetrated when the stitch pattern 16 is formed. Therefore, the holes 30 are provided along the sewn part 28 at certain intervals in accordance with the pitch of the stitch.

Each of the holes 30 is provided preferably along a penetrating direction of the sewing needle. For example, in a case where the penetrating direction of the sewing needle is parallel to a direction orthogonal to the front surface 24 of the base material 20, the hole 30 is preferably provided along a straight line orthogonal to the front surface 24 of the base material 20. However, the hole 30 does not need to be provided along the penetrating direction of the sewing needle because it is only necessary that the resistance in inserting the sewing needle into the base material 20 is decreased or the slipping of the sewing needle on the front surface 24 can be prevented.

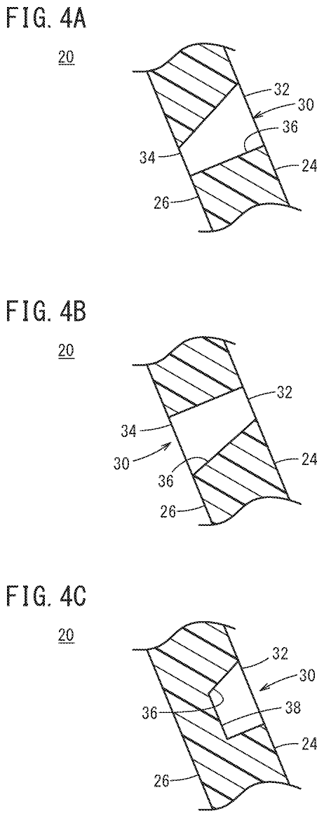

The holes 30 may penetrate the base material 20 from the front surface 24 side to a back surface 26 side as illustrated in FIG. 4A and FIG. 4B, or need not necessarily penetrate the base material 20 from the front surface 24 side to the back surface 26 side as illustrated in FIG. 4C. A central axis of the hole 30 may be parallel to the straight line orthogonal to the front surface 24 or a little tilted from the straight line orthogonal to the front surface 24.

The hole 30 illustrated in FIG. 4A includes a front surface opening 32 on the front surface 24 of the base material 20 and a back surface opening 34 with a smaller diameter than that of the front surface opening 32 on the back surface 26. The hole 30 includes an inner circumferential surface 36 that is tapered from the front surface opening 32 to the back surface opening 34.

The hole 30 illustrated in FIG. 4B includes the front surface opening 32 on the front surface 24 of the base material 20 and the back surface opening 34 with a larger diameter than that of the front surface opening 32 on the back surface 26. The hole 30 includes the inner circumferential surface 36 that is inversely-tapered from the front surface opening 32 to the back surface opening 34. The hole 30 illustrated in FIG. 4C includes the front surface opening 32 on the front surface 24 of the base material 20 and a bottom part 38 on the back surface side compared with the front surface opening 32. The hole 30 includes the inner circumferential surface 36 that is tapered from the front surface opening 32 to the bottom part 38.

### [2. Manufacturing Method for Sewn Workpiece 10]

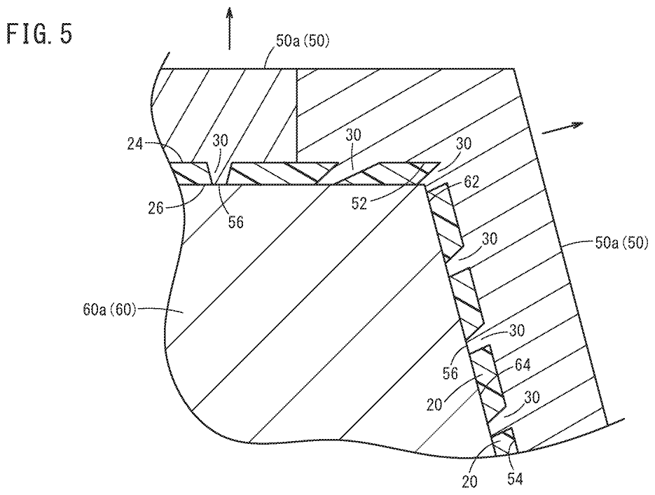

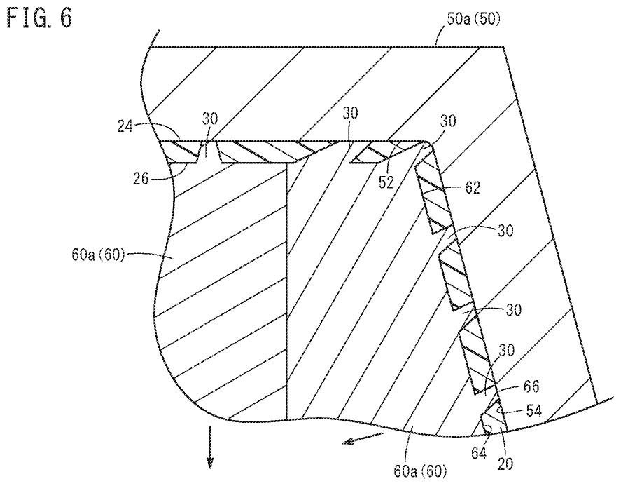

The base material 20 of the sewn workpiece 10 is manufactured by injection molding with an injection molding apparatus that is not illustrated. As illustrated in FIG. 5 and FIG. 6, the injection molding apparatus includes a first die 50 for molding the front surface 24 side of the base material 20 and a second die 60 for molding the back surface 26 side of the base material 20. When the first die 50 and the second die 60 are closed, a cavity is formed therebetween. Into this cavity, a molten resin material is injected, and then, the resin material is dwelled (or the pressure thereof being kept) and cooled; thus, the base material 20 is molded. Note that in FIG. 5, each arrow indicates a direction where the first die 50 moves when the first die 50 is released from the base material 20. Similarly, in FIG. 6, each arrow indicates a direction where the second die 60 moves when the second die 60 is released from the base material 20.

The first die 50 is formed by one or more insert dies 50a. Similarly, the second die 60 is formed by one or more insert dies 60a. The first die 50 includes a first bend molding part 52 for molding the bent part 22 of the base material 20. Similarly, the second die 60 includes a second bend molding part 62 for molding the bent part 22 of the base material 20.

In the example illustrated in FIG. 5, the base material 20 is molded using the first die 50 including a plurality of first protrusions 56. Each of the first protrusions 56 is configured to protrude from a first mold surface 54 of the first die 50, more specifically provided at a position corresponding to the sewn part 28 of the base material 20 (including the first bend molding part 52). In order to make it easier to release the die from the sewn workpiece 10, each first protrusion 56 is tapered from a root to an end. The height of each first protrusion 56 is, for example, such a degree that the end of the first protrusion 56 is in contact with a second mold surface 64 of the second die 60 when the first die 50 and the second die 60 are closed. In this case, to the base material 20, the hole 30 that penetrates as illustrated in FIG. 4A is molded by the first protrusion 56. Alternatively, the height of each first protrusion 56 may be such a degree that the end of the first protrusion 56 is not in contact with the second mold surface 64 of the second die 60 when the first die 50 and the second die 60 are closed. In this case, to the base material 20, the hole 30 with the bottom as illustrated in FIG. 4C is molded by the first protrusion 56.

In the example illustrated in FIG. 6, the base material 20 is molded using the second die 60 including a plurality of second protrusions 66. Each of the second protrusions 66 is configured to protrude from the second mold surface 64 of the second die 60, more specifically provided at the position corresponding to the sewn part 28 of the base material 20 (including the first bend molding part 52). In order to make it easier to release the die from the sewn workpiece 10, each second protrusion 66 is tapered from a root to an end. The height of each second protrusion 66 is such a degree that the end of the second protrusion 66 is in contact with the first mold surface 54 of the first die 50 when the first die 50 and the second die 60 are closed. In this case, to the base material 20, the through hole 30 as illustrated in FIG. 4B is molded.

To the front surface 24 of the molded base material 20, the skin 40 is attached with an adhesive or the like, and the sewn part 28 is sewed while a sewing machine is moved with a robot or the like. Thus, the stitch pattern 16 as illustrated in FIG. 3 is formed on the sewn workpiece 10. Since the robot stores the positions of the holes 30, the end of the sewing needle can be inserted into the holes 30.

[3. Technical Concept Obtained from Embodiment]

The technical concept that is obtained from the above embodiment is hereinafter described.

The first aspect of the present invention is the sewn workpiece 10 in which the sewn part 28 that needs to be sewed is provided to the base material 20 made of resin, wherein: the sewn part 28 includes the bent part 22; and the hole 30 is provided in the bent part 22 at the position where the sewing needle is penetrated.

By the above structure, the hole 30 is provided to the bent part 22 of the base material 20 in advance; therefore, the reaction force that the sewing needle receives from the base material 20 in the sewing of the bent part 22 can be reduced. In addition, since the end of the sewing needle is inserted into the hole 30 in the sewing of the bent part 22, the sewing needle does not slip on the front surface 24 of the bent part 22 and the needle slip, the needle break, and the sewing failure can be prevented.

In the sewn workpiece 10, the hole 30 may penetrate from the front surface 24 side to the back surface 26 side of the bent part 22 (FIG. 4A, FIG. 4B).

In the sewn workpiece 10, the hole 30 may include the opening (front surface opening 32) on the front surface 24 of the bent part 22, and the bottom part 38 on the back surface 26 side of the bent part 22 compared with the opening (front surface opening 32) (FIG. 4C).

The second aspect of the present invention is the method of molding the sewn workpiece 10 for molding the base material 20 made of resin including the sewn part 28 that needs to be sewed, wherein the injection molding is performed using the die (first die 50 or second die 60) including the protrusion (first protrusion 56 or second protrusion 66) in the bend molding part (first bend molding part 52 or second bend molding part 62), in a manner that the bent part 22 is molded in the sewn part 28 of the base material 20 by the bend molding part and that the hole 30 is molded in the bent part 22 by the protrusion at the position where the sewing needle is penetrated.

By the above structure, the sewn workpiece 10 in which the reaction force that the sewing needle receives from the base material 20 is reduced can be manufactured. In this sewn workpiece 10, the needle slip, the needle break, and the sewing failure can be prevented.

In the molding method for the sewn workpiece 10, in the molding of the base material 20, the hole 30 may penetrate from the front surface 24 side to the back surface 26 side of the bent part 22 (FIG. 4A, FIG. 4B, FIG. 5, FIG. 6).

In the molding method for the sewn workpiece 10, in the molding of the base material 20, the opening (front surface opening 32) of the hole 30 may be molded on the front surface 24 of the bent part 22 and the bottom part 38 may be molded on the back surface 26 side of the bent part 22 compared with the opening (front surface opening 32) (FIG. 4C).

Note that the sewn workpiece and the molding method for the same according to the present invention are not limited to the above embodiment, and can employ various structures without departing from the gist of the present invention.

What is claimed is:

1. A sewn workpiece in which a sewn part that needs to be sewed is provided to a base material made of resin, wherein:
the sewn part includes a bent part; and
a hole is provided in the bent part at a position where a sewing needle is penetrated.

2. The sewn workpiece according to claim 1, wherein the hole penetrates from a front surface side to a back surface side of the bent part.

3. The sewn workpiece according to claim 1, wherein the hole includes an opening on a front surface of the bent part, and a bottom part on a back surface side of the bent part compared with the opening.

4. A method of molding a sewn workpiece for molding a base material made of resin including a sewn part that needs to be sewed,
wherein injection molding is performed using a die including a protrusion in a bend molding part, in a manner that a bent part is molded in the sewn part of the base material by the bend molding part and that a hole is molded in the bent part by the protrusion at a position where a sewing needle is penetrated.

5. The method of molding the sewn workpiece according to claim 4, wherein in the molding of the base material, the hole penetrates from a front surface side to a back surface side of the bent part.

6. The method of molding the sewn workpiece according to claim 4, wherein in the molding of the base material, an opening of the hole is molded on a front surface of the bent part and a bottom part is molded on a back surface side of the bent part compared with the opening.
